(19) United States
(12) Patent Application Publication
(10) Pub. No.: US 2021/0348277 A1
(43) Pub. Date: Nov. 11, 2021

(54) METHOD FOR NI-FREE PHOSPHATIZING OF METAL SURFACES AND COMPOSITION FOR USE IN SUCH A METHOD

(71) Applicants: Rhodia Operations, Aubervilliers (FR); Chemetall GmbH, Frankfurt (DE)

(72) Inventors: Nawel Souad Khelfallah, Frankfurt am Main (DE); Olaf Dahlenburg, Frankfurt am Main (DE); Lisa Seider, Frankfurt am Main (DE); Marie-Pierre Labeau, Sèvres (FR); Guillaume Gody, Rueil-Malmaison (FR)

(21) Appl. No.: 17/282,607

(22) PCT Filed: Oct. 8, 2019
(86) PCT No.: PCT/EP2019/077242

§ 371 Date: Apr. 2, 2021

(30) Foreign Application Priority Data
Oct. 8, 2018 (EP) 18199098.7

(51) Int. Cl. C23C 22/18; C09D 4/00; C09D 143/02; C09D 133/02; C09D 153/00; C23C 22/83; C23C 22/78; C23C 22/73

(52) U.S. Cl. CPC C23C 22/182; C09D 4/00; C09D 143/02; C23C 22/73; C09D 153/00; C23C 22/83; C23C 22/78; C09D 133/02

(57) ABSTRACT

Described herein is a method for treatment of at least one surface of a metal containing substrate including contacting the surface with an aqueous acidic Ni-free composition (A) including at least zinc cations, manganese cations, and phosphate anions to form a conversion coating on the surface, and contacting the formed coating with an aqueous Ni-free composition (B) including one or more linear polymers (P) containing vinyl phosphonic acid and (meth)acrylic acid in form of their polymerized monomeric units. Also described herein is a composition (B) as such, a master batch to produce the composition (B), a kit-of-parts including both compositions (A) and (B), a kit-of-parts including respective master batches to produce both compositions (A) and (B), and a coated substrate obtainable by the method described herein.

The present invention relates to a method for treatment of at least one surface of a metal containing substrate comprising at least steps (1) and (3), namely contacting said surface with an aqueous acidic Ni-free composition (A) comprising at least zinc cations, manganese cations and phosphate anions to form a conversion coating on the surface (1) and contacting said formed coating with an aqueous Ni-free composition (B) comprising one or more linear polymers (P) containing vinyl phosphonic acid and (meth)acrylic acid in form of their polymerized monomeric units, to said composition (B) as such, to a master batch to produce said composition (B), to a kit-of-parts comprising both compositions (A) and (B) as well as to a kit-of-parts comprising respective master batches to produce both compositions (A) and (B) as well as to a coated substrate obtainable by the inventive method.

### BACKGROUND OF THE INVENTION

The use phosphate coatings on metallic surfaces is known in the prior art. Such coatings serve as protection against corrosion of the metallic surfaces and, moreover, also as adhesion promoters for subsequent coating layers. Such phosphate coatings are mainly used in the automotive industry and the general industry. In addition to powder coatings and wet paints, subsequent coating layers applied onto such a phosphate coating are mainly cathodically electrodeposited paints. Since during the deposition of said electrodeposition paints a current flow must be provided between the metallic surface and the treatment bath, it is important to adjust a defined electrical conductivity of the phosphate coating in order to ensure efficient and homogeneous deposition. Therefore, phosphate coatings are usually applied by means of a nickel-containing phosphatizing solution. Deposition of nickel ensures a suitable conductivity of the coating in the subsequent electrodeposition coating.

However, nickel ions, because of their high toxicity and environmental toxicity, are no longer desirable as part of treatment solutions and should therefore be avoided or at least reduced in their content as much as possible.

The use of nickel-free or low-nickel phosphatizing solutions is known in principle. However, this is usually limited to certain substrates such as bare steel. Further, the conversion coating(s) produced hereby are not always able to provide sufficient corrosion protection and paint adhesion.

### Problem

Therefore, the object of the present invention is to provide a method for providing a nickel-free phosphate coating onto metallic surfaces of substrates, by which the disadvantages associated with the use of nickel cations such as their high toxicity and the resulting environmental toxicity can be avoided, but which at the same time provides at least the same or even an improved corrosion protection of the substrate and/or no disadvantages or even advantages with respect to the resulting adhesion properties when applying further coatings such as electrodeposition paints onto.

### Solution

This object has been solved by the subject-matter of the claims of the present application as well as by the preferred embodiments thereof disclosed in this specification, i.e. by the subject matter described herein.

A first subject-matter of the present invention is thus a method for treatment of at least one surface of a substrate, wherein said surface is at least partially made of at least one metal, comprising at least steps (1) and (3), namely,
(1) contacting said at least one surface with an acidic aqueous composition (A) being free from nickel cations to form a conversion coating on said surface, the acidic aqueous composition (A) comprising at least
   (a-i) zinc cations,
   (a-i) manganese cations and
   (a-iii) phosphate anions,
(2) optionally rinsing and/or drying the conversion coating obtained after step (1) and
(3) contacting the conversion coating obtained after step (1) or optionally after step (2) with an aqueous composition (B), the aqueous composition (B) being free from nickel cations, being different from acidic aqueous composition (A) and comprising one or more linear polymers (P) prepared by controlled radical polymerization containing
   (m1) vinyl phosphonic acid and
   (m2) (meth)acrylic acid
   in form of their polymerized monomeric units,
   wherein 85 to 95 mol-% of the polymerized monomeric units are polymerized monomeric units of (meth)acrylic acid (m2), and the rest of the polymerized monomeric units are polymerized monomeric units of vinylphosphonic acid (m1).

A further subject-matter of the present invention is the aqueous composition (B) used in step (3) of the inventive method, i.e. an aqueous composition (B), which is free from nickel cations and comprises one or more linear polymers (P) prepared by controlled radical polymerization containing
(m1) vinyl phosphonic acid and
(m2) (meth)acrylic acid
in form of their polymerized monomeric units,
wherein 85 to 95 mol-% of the polymerized monomeric units are polymerized monomeric units of (meth)acrylic acid (m2), and the rest of the polymerized monomeric units are polymerized monomeric units of vinyl phosphonic acid (m1).

A further subject-matter of the present invention is a master batch to produce the inventive aqueous composition (B) by diluting the master batch with water and if applicable by adjusting the pH value.

A further subject-matter of the present invention is a kit-of-parts comprising an inventively used acidic aqueous composition (A), i.e. the acidic aqueous composition (A) used in step (1) of the inventive method, and an inventive aqueous composition (B) as used in step (3) of the inventive method.

A further subject-matter of the present invention is a kit-of-parts comprising a master batch to produce the inventively used acidic aqueous composition (A) used in step (1) of the inventive method by diluting the master batch with water and if applicable by adjusting the pH value, and an inventive master batch to produce the inventive aqueous composition (B) by diluting the master batch with water and if applicable by adjusting the pH value.

An additional subject-matter of the present invention is a coated substrate obtainable by the inventive method.

It has been surprisingly found that due to the presence of the inventively used polymer (P) in composition (B) the properties of the coatings formed by the contacting steps (1) and (3), particularly their ability to provide a sufficient corrosion protection, can be significantly improved.

### DETAILED DESCRIPTION OF THE INVENTION

The term “comprising” in the sense of the present invention, in particular in connection with the inventive method, the inventive(ly used) composition (A), the inventive composition (B) and the inventive master batches, preferably has the meaning “consisting of”. In this case, for example, with regard to inventively composition (A), in addition to the mandatory constituents therein (components (a-i), (a-ii), (a-iii) and water) one or more of the other optional components mentioned hereinafter may be contained in the composition. The same applies in to inventive composition (B) and the inventive master batches. All components can be present in each case in their preferred embodiments mentioned hereinafter. The same applies to the further subject-matter of the present invention.

Inventive Method—Step (1)

Step (1) of the inventive method is a contacting step, wherein at least one surface of a substrate, said surface being at least partially made of at least one metal, is contacted with an acidic aqueous composition (A), in order to form a conversion coating on said surface.

The surface of the substrate used is at least partially made of at least one metal, i.e. at least one region of said surface is made of at least one metal. The surface can consist of different regions comprising different metals. Preferably, the overall surface of the substrate is made of at least one metal. More preferably, the substrate consists of at least one metal.

Preferably, the at least one metal is selected from the group consisting of aluminum, aluminum alloys, zinc, steel including cold rolled steel, hot rolled steel, galvanized steel (zinc plated steel), and particularly preferred hot-dip galvanized steel (hot zinc dipped steel) or electrolytically galvanized steel, magnesium and/or zinc-magnesium alloys and/or zinc-iron alloys and mixtures thereof.

The at least one metal is in particular an aluminum magnesium alloy, including, but not limited to alloys of the so-called AA1000, AA2000, AA3000, AA4000, AA5000, AA6000, AA7000 as well as AA8000 series. In particular, alloys such as AA5754 (Al: 94.2—Mg: 2.6—Si: 0.4—other: 2.8), AA6014 (Al: 97.1—Mg: 0.4—Si: 0.3—other: 2.2) and AA6111 (Al: 97.3—Cu: 0.7—Mg: 0.6—Si: 0.8—other: 0.6) as well as AA6016 can be used. With the method of the invention, a mixture of different substrates can be treated in the same bath (so-called “multi-metal capacity”).

The treatment procedure according to step (1), i.e. the “contacting”, can, for example, include a spray coating and/or a dip coating procedure. The composition (A) can also be applied by flooding the surface or by roll coating or even manually by wiping or brushing. However, dipping is preferred. In this case, the substrate used is dipped into a bath containing the composition (A).

The treatment time, i.e. the period of time the surface is contacted with the acidic aqueous composition (A) used in step (1) is preferably from 15 seconds to 20 minutes, more preferably from 30 seconds to 10 minutes, and most preferably 45 seconds to 5 minutes, as for example 1 to 4 minutes.

The temperature of the acidic aqueous composition (A) used in the inventive method for treatment is preferably from 20 to 65° C., more preferably from 30 to 60° C. and most preferably from 35 to 55° C.

Preferably, by performing step (1) of the inventive method a conversion coating layer is formed on the at least one surface of the substrate. In particular, by performing contacting step (1) a coating is preferably formed that preferably has a zinc phosphate coating weight determined by XRF (X-ray fluorescence spectroscopy) of:

| | zinc phosphate coating weight (g/m²) | |
|---|---|---|
| Surface of substrate | preferably | in particular |
| steel | 0.5 to 6 | 1 to 5 |
| hot-dip galvanized steel | 1.0 to 6 | 1.5 to 5 |
| electrolytically galvanized steel | 1.0 to 6 | 1.5 to 5 |
| aluminum or aluminum alloy | 0.5 to 6 | 1 to 5 |

The surfaces to be treated may be cleaned by means of an acidic, alkaline or pH-neutral cleaning composition and/or etched before treatment with the acidic aqueous composition (A) as it will be outlined hereinafter: Prior to step (1) of the inventive method one or more of the following optional steps can be performed in this order:
Step (A-1): cleaning and optionally subsequently rinsing the surface of the substrate used in step (1),
Step (B-1): subjecting the surface of the substrate to acidic pickling, i.e., etching, and subsequently rinsing the surface of the substrate,
Step (C-1): contacting the surface of the substrate with an aqueous activating composition, said aqueous composition being different from composition (A) and (B), and
Step (D-1): rinsing the surface of the substrate obtained after the contact according to step (C-1) and/or (B-1).

Alternatively, steps (A-1) and (B-1) may be performed in one step, which is preferred. Preferably, both steps (A-1) and (B-1) are performed.

The aqueous composition used in step (C-1) is an activating composition. The activating composition is used to deposit a plurality of ultrafine phosphate particles as seed crystals on the metal surface of the substrate used in step (1). These crystals help in the subsequent process step (1) to form a particular crystalline phosphate layer with the highest possible number of densely arranged fine phosphate crystals or a substantially closed phosphate layer on the surface. Thus, the activating composition preferably contains a phosphate such as titanium phosphate and/or zinc phosphate. Again, alternatively, it may also be advantageous to add at least one of such activating agents, in particular titanium phosphate and/or zinc phosphate, to the cleaning composition used in optional step (A-1) in order to carry out cleaning and activation in one step.

Rinsing step (D-1) and the optional rinsing being part of step (A-1) are preferably performed by using deionized water or tap water. Preferably, step (D-1) is performed by using deionized water.

Inventively Used Composition (A)

Acidic aqueous composition (A) as used in step (1) of the inventive method is free from nickel cations and comprises at least (a-i) zinc cations, (a-ii) manganese cations and (a-iii) phosphate anions. Composition (A) is different from inventive composition (B) as used in step (3) of the inventive method. Cations (a-i) and (a-ii) are preferably incorporated into composition (A) in the form of their phosphates, i.e., in the form of zinc phosphate and manganese phosphate. Thus, cations (a-i) and (a-ii) and anions (a-iii) are preferably incorporated into composition (A) in the form of zinc phosphate and manganese phosphate.

Since composition (A) comprises (a-iii) phosphate anions it represents a phosphatizing composition, which is suitable of forming a conversion coating on the surface of a substrate.

The term “aqueous” with respect to the inventively used composition (A) in the sense of the present invention preferably means that the composition (A) is a composition containing at least 50 wt.-%, preferably at least 60 wt.-%, more preferably at least 70 wt.-% in particular at least 80, most preferably at least 90 wt.-% of water, based on its total content of organic and inorganic solvents including water. Thus, the composition (A) may contain at least one organic solvent besides water—however, in an amount lower than the amount of water present.

The term “acidic” means that the composition (A) has a pH value of less than 7 at room temperature (23° C.). The pH value of the acidic aqueous composition is preferably in the range of 0.5 to 6.9 or of 0.5 to 6.5, more preferred 2.0 to 6.0, even more preferred 2.5 to 5.5, particularly preferred 3.0 to 5.0 and most preferred 3.1 to 4.5. The pH can be preferably adjusted by using nitric acid, aqueous ammonia and/or sodium carbonate.

Composition (A) preferably has a temperature in the range of from 20 to 65° C., more preferably of from 30° C. to 60° C., in particular 35° C. or to 55° C.

The acidic aqueous composition (A) is preferably used as a dip coat bath. However, it can also be applied by virtually any conventional coating procedure like e.g. spray coating, roll coating, brushing, wiping etc. as outlined above in connection with step (1).

The term “free from nickel cations” in the sense of the present invention preferably means that nickel cations are present in in the composition (A) in an amount of less than 0.2 g/l, more preferably less than 0.1 g/l, even more preferably less than 0.05 g/l and in particular less than 0.01 g/l. The same applies to composition (B), which is also free of nickel cations. If such minor amounts of nickel cations are present in composition (A) and/or (B), they are present therein merely in a form of contamination of the composition (A) and/or (B): nickel cations are not added on purpose to composition (A) and (B).

The content of nickel cations as well as of all further cations and anions mentioned hereinafter both with respect to composition (A) and composition (B) can be monitored and determined by the means of ICP-OES (optical emission spectroscopy with inductively coupled plasma). Said method is described hereinafter in detail. The content of free fluoride anions is, however, determined by means of a fluoride electrode.

Preferably, acidic aqueous composition (A) comprises zinc cations (a-i) in an amount of 0.3 to 3.0 g/l, more preferably of 0.5 to 2.0 g/l.

Preferably, acidic aqueous composition (A) comprises manganese cations (a-ii) in an amount of 0.3 to 3.0 g/l, more preferably of 0.5 to 2.0 g/l, even more preferably of 0.6 to 1.8 g/Il.

Preferably, acidic aqueous composition (A) comprises phosphate anions in an amount of 8.0 to 25.0 g/I, more preferably of 10.0 to 18.0 g/l (calculated as P₂O₅).

The term “phosphate anions” in the sense of the present invention preferably includes hydrogen phosphate, dihydrogen phosphate and phosphoric acid. In addition, pyrophosphoric acid and polyphosphoric acid as well as all their partially and completely deprotonated forms are preferably also included.

In particular, acidic aqueous composition (A) comprises
zinc cations (a-i) in an amount of 0.3 to 3.0 g/l, preferably of 0.5 to 2.0 g/l, and
manganese cations (a-i) in an amount of 0.3 to 3.0 g/I, preferably of 0.5 to 2.0 g/l, even more preferably of 0.6 to 1.8 g/l and
phosphate anions in an amount of 8.0 to 25.0 g/l, preferably of 10.0 to 18.0 g/l (calculated as P₂O₅).

Optional Components of Composition (A)

The inventively used aqueous composition (A) may comprise further components including ions. Optional components as described hereinafter are different from one another and also different from mandatory components (a-i), (a-ii) and (a-iii) as well as from water when any of these optional components is present in the composition (A).

Preferably, acidic aqueous composition (A) comprises fluoride anions in an amount of 10 to 250 mg/l, more preferably of 30 to 200 mg/l, even more preferably of 40 to 150 mg/l, and/or flurometalate anions in an amount of 0.05 to 5.0 g/I, more preferably of 0.1 to 3.0 g/I, even more preferably of 0.5 to 2.5 g/l. Preferably, fluoride anions are free fluoride anions, which are present in composition (A), e.g., by using sodium fluoride.

Fluoride anions in this sense are “free” fluoride anions, which are not coordinated to any metals or semimetals to form “complex fluorides” as it is the case for fluorometalate anions.

Flurormetalate anions are preferably fluoride anions coordinated to a metal or semimetal. Examples are tetrafluoro complexes and/or hexafluoro complexes, in particular tetrafluorometalate anions Z(F)₄⁻ with Z═B and/or hexafluorometalate anions Z(F)₆²⁻ with Z═Si. The fluorometalate content then refers to, for example, hexafluorosilicate (SiF₆²⁻) or tetrafluoroborate (BF₄⁻).

In particular when substrates in the inventive method are used, which have surfaces being at least partially made of aluminum and/or galvanized material the presence of fluoride anions and/or fluorometalate anions in composition (A) is advantageous when performing step (1) of the inventive method. Optionally present trivalent aluminum cations are a bad poison in phosphatizing compositions such as composition (A) and may be complexed with fluorides and thus removed from the system. Flurometalate anions are advantageously added to the composition (A) as “fluoride buffer” in order to avoid that the fluoride anion content rapidly drops. Flurometalate anions also help on galvanized material to avoid defects such as specks.

If iron cations such as iron(III) cations are additionally optionally contained in the composition (A), their content is preferably in the range of from 1 to 200 mg/l, more preferably of from 1 to 100 mg/l, even more preferably of from 5 to 100 mg/l, particularly preferably of from 5 to 50 mg/l and most preferably of from 5 to 20 mg/l. The presence of these iron cations can improve the stability of the composition (A). Such cations may be added to the composition (A), for example as nitrate, sulfate, citrate or tartrate salt. However, the iron cations ions are preferably not added as nitrate, since an amount of nitrate too high may adversely affect the composition (A), for example by reducing its manganese cation content, which in turn may lead to lowering of the alkali resistance of the resulting coating due to an inclusion of manganese to a lesser extent in the conversion coating formed.

Thus, preferably, acidic aqueous composition (A) comprises nitrate anions in an amount of less than 1 g/l, more preferably less than 0.5 g/I, even more preferably less than 0.1 g/l and in particular less than 0.01 g/l.

Composition (A) may optionally contain at least one accelerator, which preferably is selected from the group consisting of hydrogen peroxide (H₂O₂), nitrite anions, nitro guanidine, hydroxyl amine and mixtures thereof.

The amount of hydrogen peroxide when used as the sole accelerator is preferably in the range of 5 to 200 mg/l, more preferably 10 to 100 mg/l, and most preferably 15 to 50 mg/l. The amount of nitrite when used as the sole accelerator is preferably in the range of 30 to 300 mg/l, more preferably in the range of 60 to 150 mg/l. The amount of nitroguanidine when used as the sole accelerator is preferably in the range of 0.1 to 3.0 g/I, more preferably in the range of 0.2 to 3.0 g/l, and most preferably in the range from 0.2 to 1.55 g/l. The amount of hydroxyl amine when used as the sole accelerator is preferably in the range of 0.1 to 5.0 g/I, more preferably in the range of 0.4 to 3.0 g/l.

In particular, hydrogen peroxide (H₂O₂) is used as accelerator in composition (A).

Preferably, composition (A) can be further characterized by its content of free acid (FA) and/or its content of free acid diluted (FA dil.) and/or its content of total Fischer acid (TAF) and/or its total acid (TA) content and/or its acid value (S-value) as outlined below:

| | preferably | in particular |
|---|---|---|
| FA | 0.3 to 2.0 | 0.7 to 1.6 |
| FA dil. | 0.5 to 8 | 1 to 6 |
| TAF | 12 to 28 | 22 to 26 |
| TA | 12 to 45 | 18 to 35 |
| S-value | 0.01 to 0.2 | 0.03 to 0.15 |

The methods for determining each of these parameters are described hereinafter in the “test methods” section.

Inventive Method—Optional Step (2)

Optional step (2) of the inventive method is a step, wherein the conversion coating obtained after step (1) is optionally rinsed and/or dried.

After step (1) of the method according to the invention the surface of the substrate obtained after contact according to step (1) can be rinsed, preferably with deionized water or tap water. Rinsing step (2) may be carried out in order to remove excess components present in composition (A) used in step (1).

In one preferred embodiment, rinsing step (2) is carried out after step (1). In another preferred embodiment, no rinsing step (2) is performed.

After step (1) of the method according to the invention or alternatively after having performed a rinsing as part of optional step (2), an additional drying step may be performed, e.g. at a temperature in the range of 35° C. to 100° C.

Inventive Method—Step (3)

Step (3) of the inventive method is a contacting step, wherein the conversion coating obtained after step (1) or optionally after step (2) is contacted with an aqueous composition (B), the aqueous composition (B) being free from nickel cations, being different from acidic aqueous composition (A) and comprising one or more linear polymers (P).

Preferably, by performing step (3) of the inventive method a coating layer is formed onto the conversion coating layer formed after performance of step (1).

The treatment procedure according to step (3), i.e. the “contacting”, can, for example, include a spray coating and/or a dip coating procedure. The composition (B) can also be applied by flooding the surface or by roll coating or even manually by wiping or brushing. However, dipping is preferred. In this case, the substrate used in dipped into a bath containing the composition (B).

The treatment time, i.e. the period of time the surface is contacted with the aqueous composition (B) used in step (3) is preferably from 10 seconds to 20 minutes, more preferably from 20 seconds to 10 minutes, and most preferably 30 seconds to 5 minutes, as for example 30 seconds to 2 or 3 minutes.

The temperature of the aqueous composition (B) used in the inventive method for treatment is preferably from 20 to 65° C., more preferably of from 15° C. to 40° C., in particular 17° C. or to 35° C.

Inventive Composition (B) Used in the Inventive Method

Aqueous composition (B) as used in step (3) of the inventive method is free from nickel cations, different from acidic aqueous composition (A) used in step (1) and comprises one or more linear polymers (P) prepared by controlled radical polymerization containing (m1) vinyl phosphonic acid and (m2) (meth)acrylic acid in form of their polymerized monomeric units, wherein 85 to 95 mol-% of the polymerized monomeric units are polymerized monomeric units of (meth)acrylic acid, and the rest of the polymerized monomeric units are polymerized monomeric units of vinyl phosphonic acid.

Composition (B) represents a composition, which is suitable for rinsing such as for rinsing the coating applied in step (1) of the inventive method on the surface of the substrate used. Composition (B) is thus preferably a solution, i.e. a rinsing solution.

The term “aqueous” with respect to the inventively used composition (B) in the sense of the present invention has the same meaning as outlined hereinbefore in connection with composition (A).

Preferably, composition (B) is an aqueous acidic composition. The term “acidic” with respect to the inventively used composition (B) in the sense of the present invention has the same meaning as outlined hereinbefore in connection with composition (A). The pH of composition (B) can be in the preferred ranges as outlined hereinbefore in connection with composition (A).

Composition (B) preferably has a temperature in the range of from 20 to 65° C., more preferably of from 15° C. to 40° C., in particular 17° C. or to 35° C.

Polymer (P) is preferably present in composition (B) in an amount in the range from 5 to 5000 ppm, more preferably in the range from 10 to 4000 ppm, still more preferably in the range from 20 to 3500 ppm, even more preferably in the range from 30 to 3000 ppm and most preferably in the range from 40 to 2500 ppm, as e.g. 50 to 2000 ppm or 100 to 1500 ppm, based in each case on the total weight of the aqueous composition (B). In particular, polymer (P) is preferably present in composition (B) in an amount in the range from 10 to 1000 ppm, more preferably in the range from 20 to 500 ppm.

Polymer (P) is preferably soluble in composition (B). Solubility is determined at a temperature of 20° C. and atmospheric pressure (1.013 bar).

Polymer (P) is a “(meth)acryl polymer”, which is formed from “acryl monomers” and/or “methacryl monomers”, but also has non-acryl and non-methacryl units due to the use of monomer (m1). The term “(meth)acryl” means “acryl” and/or “methacryl”. Similarly, “(meth)acrylate” means acrylate and/or methacrylate.

The term “polymerized monomeric unit” means the unit generated by polymerization of the respective monomer. For example, the polymerized monomeric unit of vinyl phosphonic acid (H₂C═CH—P(═O)(OH)₂) is H₂C*—C*H—P(═O)(OH)₂, wherein the asterisks denote the carbon atoms bound to the adjacent polymerized monomeric units, which form the polymeric backbone of polymer (P).

Polymer (P) is a linear polymer. The monomeric units can be arranged statistically, in two or more blocks or as a gradient along the polymeric backbone of polymer (P). However, such arrangements can also be combined.

The polymers (P) are prepared by controlled radical polymerization. Polymer (P) is specifically prepared by a controlled radical polymerization of monomers (m1) and (m2), said polymerization being carried out continuously or batchwise. Preferably, the one or more polymers (P) are random copolymers obtained by a controlled radical copolymerization of monomers (m1) and (m2), namely copolymers obtained by contacting these monomers, a free radical source and a radical polymerization control agent.

The inventively used polymer (P) may contain only one kind of each monomeric units (m2), but also may comprise different kinds of monomeric units (m2).

Preferably, polymer (P) has a degree of polymerization in the range of 30 to 500, more preferably of 40 to 480 and most preferably of 55 to 400.

Preferably, polymer (P) has a number average molecular weight Mₙ, which is preferably in the range of 5,000 to 60,000 g/mol, more preferably of 10,000 to 50,000 30 g/mol, more preferably of 10,000 to 47,000 g/mol and most preferably of 10,000 to 42,000 g/mol. The number average number and weight molecular weight (respectively) Mₐ and M_{w} are determined by the method described hereinafter.

Preferably, polymer (P) present in aqueous composition (B) consists of vinyl phosphonic acid (m1) and (meth)acrylic acid (m2) in form of their polymerized monomeric units.

Preferably, polymer (P) preferably is a block copolymer or a random copolymer, which preferably contains
vinyl phosphonic acid monomeric units (m1) present in the polymer in an amount of 5 to 15 mole-%, more preferably 7 to 13 mole-%, and
(meth)acrylic acid monomeric units (m2) present in the polymer in an amount of 85 to 95 mole-%, more preferably of 87 to 93 mole-%,
   in each case based on the total amount of all monomeric units of polymer (P), wherein the sum of all monomeric units present in polymer (P) adds up to 100 mole-%.

As outlined above a radical polymerization control agent is preferably used for preparing the inventively used polymer (P). Herein, the term “radical polymerization control agent” (or more concisely “control agent”) refers to a compound which is capable of extending the lifetime of the growing polymer chains in a radical polymerization reaction and of conferring, on the polymerization, a living or controlled nature. This control agent is typically a reversible transfer agent as used in controlled radical polymerization denoted by the terminology RAFT or MADIX, which typically use a reversible addition-fragmentation transfer process, such as those described, for example, in WO 96/30421, WO 98/01478, WO 99/35178, WO 98/58974, WO 00/75207, WO 01/42312, WO 99/35177, WO 99/31144, FR 2794464 or WO 02/26836.

Preferably, the radical polymerization control agent used for preparing polymer (P) is a compound which comprises a thiocarbonylthio group —S(C═S)—. Thus, for example, it may be a compound which comprises at least one xanthate group (bearing —SC═S—O-functions), for example one or two xanthates. According to one embodiment, the compound comprises several xanthates. Other types of control agent may be envisaged (for example of the type used in ATRP (Atom Transfer Radical Polymerization or NMP (Nitroxide-mediated Polymerization)). Typically, the control agent is a non-polymeric compound bearing a group that ensures control of the radical polymerization, especially a thiocarbonylthio group —S(C═S)—. According to a more specific variant, the radical polymerization control agent is a polymer, advantageously an oligomer and bearing a thiocarbonylthio —S(C═S)— group, for example a xanthate —SC═S—O— group, typically obtained by a radical polymerization monomers in the presence of a control agent bearing a thiocarbonylthio —S(C═S)— group, for example a xanthate.

A suitable control agent may, for example, have to formula (A) below:

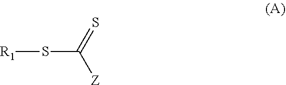

wherein:
Z represents hydrogen, chlorine, a cyano group, a dialkyl- or diarylphosphonato radical, dialkyl-phosphinato or diaryl-phosphinato radical or any of the following optionally substituted radicals: an alkyl radical, an aryl radical, a heterocyclic radical, an alkyl thio radical, an aryl thio radical, an alkoxy radical, an aryloxy radical, an amino radical, a hydrazine radical, an alkoxycarbonyl radical, an aryloxycarbonyl radical, an acyloxy or carboxyl radical, an aroyloxy radical, a carbamoyl radical, polymeric chain radical; and
R₁ represents any of the following optionally substituted radicals: an alkyl radical, an acyl radical, an aryl radical, an aralkyl radical, an alkenyl radical or alkynyl radical; or a saturated or unsaturated or aromatic, optionally substituted carbocycle or heterocycle; or a polymer chain radical, which is preferably hydrophilic or water-dispersible.

The groups R₁ or Z, when they are substituted, may be substituted with optionally substituted phenyl groups, optionally substituted aromatic groups, saturated or unsaturated carbocycles, saturated or unsaturated heterocycles, or groups chosen from the following: alkoxycarbonyl or aryloxycarbonyl (—COOR), carboxyl (—COOH), acyloxy (—O₂CR), carbamoyl (—CONR₂), cyano (—CN), alkylcarbonyl, alkylarylcarbonyl, arylcarbonyl, arylalkylcarbonyl, phthalimido, maleimido, succinimido, amidino, guanidimo, hydroxyl (—OH), amino (—NR₂), halogen, perfluoroalkyl CₙF₂ₙ₊₁, allyl, epoxy, alkoxy (—OR), S-alkyl, S-aryl, groups of hydrophilic or ionic nature, such as alkali metal salts of carboxylic acids, alkali metal salts of sulfonic acids, polyalkylene oxide (PEO, PPO) chains, cationic substituents (quaternary ammonium salts), R representing an alkyl or aryl group, or a polymer chain.

The group R₁ may alternatively be amphiphilic, i.e. it may have both hydrophilic and lipophilic nature. It is preferable for R, not to be hydrophobic.

R₁ may typically be a substituted or unsubstituted, preferably substituted, alkyl group. A control agent of formula (A) may nevertheless comprise other types of groups R₁, in particular a ring or a polymer chain radical. The optionally substituted alkyl, acyl, aryl, aralkyl or alkyne groups generally bear from 1 to 20 carbon atoms, preferably from 1 to 12 and more preferentially from 1 to 9 carbon atoms. They may be linear or branched. They may also be substituted with oxygen atoms, in particular in the form of esters, sulfur atoms or nitrogen atoms. Among the alkyl radicals, mention may be made especially of the methyl, ethyl, propyl, butyl, pentyl, isopropyl, tert-butyl, pentyl, hexyl, octyl, decyl or dodecyl radical. The alkyne groups are radicals preferably comprising 2 to 10 carbon atoms; they bear at least one acetylenic unsaturation, such as the acetylenyl radical. The acyl group is a radical preferably bearing from 1 to 20 carbon atoms with a carbonyl group. Among the aryl radicals, mention may be made especially of the phenyl radical, which is optionally substituted, in particular with a nitro or hydroxyl function. Among the aralkyl radicals, mention may be made especially of the benzyl or phenethyl radical, which is optionally substituted, in particular with a nitro or hydroxyl function. When R₁ or Z is a polymer chain radical, this polymer chain may result from a radical or ionic polymerization or from a polycondensation.

Advantageously, the control agent is selected from compounds bearing a xanthate —S(C═S)O—, trithiocarbonate, dithiocarbamate or dithiocarbazate function, for example compounds bearing an O-ethyl xanthate function of formula —S(C═S)OCH₂CH₃. Xanthates prove to be very particularly advantageous, in particular those bearing an O-ethyl xanthate —S(C═S)OCH₂CH₃ function, such as O-ethyl S-(1-(methoxycarbonyl)ethyl) xanthate (CH₃CH(CO₂CH₃))S(C═S)OEt.

Optional Components of Composition (B)

The inventively used aqueous composition (B) may comprise further components including ions. Optional components as described hereinafter are different from one another and also different from mandatory component polymer (P) as well as from water when any of these optional components is present in the composition (B).

Composition (B) may optionally contain at least one accelerator, which preferably is selected from the group consisting of hydrogen peroxide (H₂O₂), nitrite anions, nitro guanidine, hydroxyl amine and mixtures thereof. Each of these accelerators may be present in composition (B) in the same amounts as outlined hereinbefore in connection with composition (A).

Preferably, aqueous composition (B) additionally comprises one or more metal compounds (M) selected from the group of titanium compounds, zirconium compounds, hafnium compounds and mixtures thereof. The metal compounds (M) are preferably added in an amount to achieve a metal concentration of titanium, zirconium, hafnium or a mixture of these metals in the range from 20 to 5000 ppm, more preferably in the range from 25 to 4500 ppm, still more preferably in the range from 50 to 4000 ppm, even more preferably in the range from 75 to 3500 ppm and most preferably in the range from 100 to 3000 ppm, as e.g. 150 to 2500 ppm or 200 to 2000 ppm, based in each case on Ti, Zr, Hf or their combinations as metal, in composition (B).

Particularly preferred titanium, zirconium and hafnium compounds are the fluoro complexes of these metals, i.e. the corresponding fluormetalate anions, also named complex fluorides. This term includes the single and multiple protonated forms as well as the deprotonated forms. Particularly preferred is zirconium complex fluoride. It is also possible to use mixtures of such complex fluorides. In particular, composition (B) contains at least two different complex fluorides, most preferably it contains at least one titanium and at least one zirconium complex fluoride. Complex fluorides in the sense of the present invention are complexes of titanium, zirconium and/or hafnium formed with fluoride ions in composition (B), e.g. by coordination of fluoride anions to titanium, zirconium and/or hafnium cations in the presence of water. Moreover, zirconium can also be added in form of zirconyl compounds as e.g. zirconyl nitrate and zirconyl acetate; or zirconium carbonate or zirconium nitrate, the latter one being particularly preferred. The same applies to titanium and hafnium. However, the use of nitrates is not desired.

Preferably, aqueous composition (B) comprises fluoride anions and/or flurometallate anions. Composition (B) may comprise any of the fluoride anions and/or flurometallate anions in the same amounts as outlined hereinbefore in connection with composition (A).

Preferably, the inventively used aqueous composition (B) further comprises at least one of the further metal ions, which are selected from the group of metal ions as outlined below, more preferably in the preferred amounts also indicated below, in each case calculated as metal:

| Metal ion | preferably | | more preferably | | particularly | |
|---|---|---|---|---|---|---|
| Mo | 1 to 1000 | mg/l | 10 to 500 | mg/l | 20 to 225 | mg/l |
| Cu | 1 to 1000 | mg/l | 100 to 500 | mg/l | 150 to 225 | mg/l |
| Ag | 1 to 500 | mg/l | 5 to 300 | mg/l | 20 to 150 | mg/l |
| Au | 1 to 500 | mg/l | 10 to 300 | mg/l | 20 to 200 | mg/l |
| Rd | 1 to 200 | mg/l | 5 to 100 | mg/l | 15 to 60 | mg/l |
| Sn | 1 to 500 | mg/l | 2 to 200 | mg/l | 3 to 100 | mg/l |
| Sb | 1 to 500 | mg/l | 2 to 200 | mg/l | 3 to 100 | mg/l |
| Li | 1 to 100 | mg/l | 2 to 50 | mg/l | 3 to 20 | mg/l |

The metal ions optionally contained in the composition (B) are deposited either in the form of a salt, which preferably contains the corresponding metal cation (e.g. molybdenum or tin) in at least two oxidation states—in particular in the form of an oxide hydroxide, a hydroxide, a spinel or a defect spinel—or elementally on the surface to be treated when applying step (3) of the inventive method (e.g. copper, silver, gold or palladium).

In particular, molybdenum cations are present as such at least one further metal ions. These are preferably added as molybdate, more preferably as ammonium heptamolybdate and even more preferably as ammonium heptamolybdate×7 H₂O to composition (B). The molybdenum ions can also be added as sodium molybdate or in the form of at least one salt containing molybdenum cations such as molybdenum chloride, for example, and then oxidized to molybdate by a suitable oxidizing agent, for example by the accelerators described above. In such a case, composition (B) contains a corresponding oxidizing agent.

Preferably, the inventively used aqueous composition (B) further comprises at least one pH-Value adjusting substance, more preferably selected from the group consisting of nitric acid, sulfuric acid, methanesulfonic acid, acetic acid, aqueous ammonia, sodium hydroxide and sodium carbonate, wherein nitric acid, aqueous ammonia and sodium carbonate are preferred. Depending on the pH value of the aqueous composition (B), the above compounds can be in their fully or partially deprotonated form or in protonated forms.

Inventive Method—Optional Steps (4) and (5)

Optional step (4) of the inventive method is a step, wherein the coating obtained after step (3) is optionally rinsed and/or dried.

After step (3) of the method according to the invention the surface of the substrate obtained after contact according to step (3) can be rinsed, preferably with deionized water or tap water. Rinsing step (4) may be carried out in order to remove excess components present in composition (B) used in step (3).

In one preferred embodiment, rinsing step (4) is carried out after step (3). In another preferred embodiment, no rinsing step (4) is performed.

After step (3) of the method according to the invention or alternatively after having performed a rinsing as part of optional step (4), an additional drying step may be performed, e.g. at a temperature in the range of 35° C. to 100° C.

The surfaces of the substrate obtained after step (3) or after optional step (4) can be coated by further, i.e. subsequent coatings. The inventive method thus may contain at least one further optional step, namely
Step (5): applying at least one coating composition to the surface of the substrate obtained after step (3) or after optional step (4) to form a coating layer upon the surface.

The coating composition used in step (5) is different from compositions (A) and (B) and preferably comprises at least one polymer being suitable as binder, said polymer being preferably different from polymer (P). Preferably, an electrocoat is applied onto the surface of the substrate obtained after step (3) or after optional step (4) such as a cathodically depositable electrocoat. Then, step (5) may be repeated in order to apply further coatings such as at least one basecoat and subsequently a clearcoat,

Inventive Composition

A further subject-matter of the present invention is the aqueous composition (B) used in step (3) of the inventive method, i.e. an aqueous composition (B), which is free from nickel cations and comprises one or more linear polymers (P) prepared by controlled radical polymerization containing
(m1) vinyl phosphonic acid and
(m2) (meth)acrylic acid
in form of their polymerized monomeric units,
wherein 85 to 95 mol-% of the polymerized monomeric units are polymerized monomeric units of (meth)acrylic acid (m2), and the rest of the polymerized monomeric units are polymerized monomeric units of vinyl phosphonic acid (m1).

All preferred embodiments described above herein in connection with the inventive method and the inventively used composition (B), which is used in the contacting step (3) of said method, and the components contained therein, in particular polymer (P) but also all other optional components, are also preferred embodiments of inventive aqueous composition (B) as such.

Inventive Master Batch

A further subject-matter of the present invention is a master batch to produce the inventive aqueous composition (B) by diluting the master batch with water and if applicable by adjusting the pH value.

All preferred embodiments described above herein in connection with the inventive method and the inventively used composition (B), which is used in the contacting step (3) of said method, as well as with the inventive composition (B) as such, and the components contained therein, in particular polymer (P) but also all other optional components, are also preferred embodiments of inventive master batch.

If a master batch is used to produce the aqueous composition (B) according to the present invention, the master batch typically contains the ingredients of the aqueous composition (B) to be produced in the desired proportions, namely at least polymer (P), but at a higher concentration. Such master batch is preferably diluted with water to the concentrations of ingredients as disclosed above to form the aqueous composition (B). If necessary, the pH value of the aqueous composition (B) may be adjusted after dilution of the master batch.

Of course, it is also possible to further add any of the optional components to the water, wherein the master batch is diluted or to add any of the optional components after diluting the master batch with water. It is however preferred that the master batch already contains all necessary components.

Preferably, the master batch is diluted with water and/or an aqueous solution in the ratio of 1:5,000 to 1:10, more preferred 1:1,000 to 1:10, most preferred in the ratio of 1:300 to 1:10 and even more preferred 1:150 to 1:50.

Inventive Kit-of-Parts

A further subject-matter of the present invention is a kit-of-parts comprising an inventively used acidic aqueous composition (A), i.e. the acidic aqueous composition (A) used in step (1) of the inventive method, and an inventive aqueous composition (B) as used in step (3) of the inventive method.

A further subject-matter of the present invention is a kit-of-parts comprising a master batch to produce the inventively used acidic aqueous composition (A) used in step (1) of the inventive method by diluting the master batch with water and if applicable by adjusting the pH value, and an inventive master batch to produce the inventive aqueous composition (B) by diluting the master batch with water and if applicable by adjusting the pH value.

All preferred embodiments described above herein in connection with the inventive method, inventively used composition (A), and the inventively used composition (B), which is used in the contacting step (3) of said method, as well as with the inventive composition (B) as such and with the inventive master batch, and the components contained therein in each case, in particular polymer (P) but also all other optional components, are also preferred embodiments of inventive kit-of-parts.

As far as the master batch to produce the inventively used acidic aqueous composition (A) used in step (1) of the inventive method is concerned, the master batch typically contains the ingredients of the aqueous composition (A) to be produced in the desired proportions, namely at least (a-i), (a-ii) and (a-iii), but at a higher concentration. Such master batch is preferably diluted with water to the concentrations of ingredients as disclosed above to form the aqueous composition (A). If necessary, the pH value of the aqueous composition (A) may be adjusted after dilution of the master batch. Of course, it is also possible to further add any of the optional components to the water, wherein the master batch is diluted or to add any of the optional components after diluting the master batch with water. It is however preferred that the master batch already contains all necessary components.

Preferably, the master batch is diluted with water and/or an aqueous solution in the ratio of 1:5,000 to 1:10, more preferred 1:1,000 to 1:10, most preferred in the ratio of 1:300 to 1:10 and even more preferred 1:150 to 1:50.

Inventive Coated Substrate

An additional subject-matter of the present invention is a coated substrate obtainable by the inventive method.

All preferred embodiments described above herein in connection with the inventive method, inventively used composition (A), and the inventively used composition (B), which is used in the contacting step (3) of said method, as well as with the inventive composition (B) as such, with the inventive master batch and with the inventive kit-of-parts, and the components contained therein in each case, in particular polymer (P) but also all other optional components, are also preferred embodiments of coated substrate. The same applies, of course, to the embodiments of the substrate as outlined hereinbefore in connection with step (1) of the inventive method.

The coated substrate obtainable by the inventive method contains a conversion coating layer obtained by performing step (1) and further contains a coating on top of said conversion coating layer obtained by performing step (3).

Test Methods

1. Determination of Average Molecular Weights M_{w} and Mₙ

The number average and weight average molecular weights (Mₙ and M_{w}), respectively, are measured according to the following protocol: Samples are analyzed by SEC (size exclusion chromatography) equipped with a MALS detector. Absolute molar masses are obtained with a dn/dC value chosen equal to 0.1875 mL/g in order to get a recovery mass around 90%. Polymer samples are dissolved in the mobile phase and the resulting solutions are filtrated with a Millipore filter 0.45 μm. Eluting conditions are the following ones. Mobile phase: H₂O 100% vol. 0.1 M NaCl, 25 mM NaH₂PO₄, 25 mM Na₂HPO₄; 100 ppm NaN₃; flow rate: 1 mL/min; columns: Varian Aquagel OH mixed H, 8 μm, 3*30 cm; detection: RI (concentration detector Agilent)+MALLS (MultiAngle Laser Light Scattering) Mini Dawn Tristar+UV at 290 nm; samples concentration: around 0.5 wt % in the mobile phase; injection loop: 100 μL.

2. Free Acid (FA)

To determine the amount of free acid (FA), 10 m1 of the phosphating composition is pipetted into a suitable vessel, for example a 300 m1 Erlenmeyer flask. If the phosphating composition contains complex fluorides, 2-3 g of potassium chloride are added to the sample. Then, using a pH meter and an electrode, it is titrated with 0.1 M NaOH to a pH of 3.6. The consumed amount of 0.1 M NaOH in m1 per 10 m1 of the phosphating composition gives the value of the free acid (FA) in points.

3. Free Acid Diluted (FA Dil.)

To determine the amount of free acid diluted (FA dil.), 10 m1 of the phosphating composition are pipetted into a suitable vessel, for example into a 300 m1 Erlenmeyer flask. Subsequently, 150 m1 of deionized water are added. Using a pH meter and an electrode, the sample is titrated with 0.1 M NaOH to a pH of 4.7. The consumed amount of 0.1 M NaOH in m1 per 10 m1 of the diluted phosphating composition gives the value of the free acid diluted (FA dil.) in points. Based on the difference to the amount of free acid (FA), the content of complex fluorides in the sample can be determined. If this difference is multiplied by a factor of 0.36, the content of complex fluoride can be determined as SiF₆²⁻ in g/l.

4. Total Acid Diluted According to Fischer (TAF)

To determine the amount of total acid according to Fischer (TAF) following determination of the free acid diluted (FA dil.), the dilute phosphating composition is titrated to pH 8.9 after addition of potassium oxalate solution using a pH meter and an electrode with 0.1 M NaOH. The consumption of 0.1 M NaOH in m1 per 10 m1 of the diluted phosphating composition gives the total Fischer acid (TAF) in points. If this value is multiplied by a factor of 0.71, the total content of phosphate ions can be calculated as P₂O₅ (cf. W. Rausch: “The phosphation of metals.” Eugen G. Leuze-Verlag 2005, 3rd edition, pp. 332 ff).

5. Total Acid (TA) The total acid (TA) is the sum of the divalent cations present as well as free and bound phosphoric acids (the latter being phosphates). It is determined by the consumption of 0.1 M NaOH using a pH meter and an electrode. For this, 10 m1 of the phosphating composition are pipetted into a suitable vessel, for example a 300 m1 Erlenmeyer flask and diluted with 25 m1 of deionised water. It is then titrated with 0.1 M NaOH to a pH of 9. The consumption in m1 per 10 m1 of the diluted phosphating composition corresponds to the total acid score (TA).

6. Acid Value (S-Value)

The so-called acid value (S-value) is the ratio FA:TAF and results from dividing the value of the free acid (FA) by the value of the total acid according to Fischer (TAF).

7. Crosscut Testing to DIN EN ISO 2409 (06-2013)

The crosscut test is used to ascertain the strength of adhesion of a coating on a substrate in accordance with DIN EN ISO 2409 (06-2013). Cutter spacing is 2 mm. Assessment takes place on the basis of characteristic cross-cut values in the range from 0 (very good adhesion) to 5 (very poor adhesion). The crosscut test is performed before and after exposure for 240 hours in a condensation clima according to DIN EN ISO 6270-2 CH (09-2005 and the correction of 10-2007). Each of the tests is performed three times and an average value is determined.

8. Copper Catalyzed Acetic Acid Salt Spray (CASS) Mist Testing to DIN EN ISO 9227 (09-2012)

The copper catalyzed acetic acid salt spray fog test is used for determining the corrosion resistance of a coating on a substrate. In accordance with DIN EN ISO 9227 (09-2012) the samples under analysis are in a chamber in which there is continuous misting of a 5% strength common salt solution, the salt solution being admixed with acetic acid and copper chloride, at a temperature of 50° C. over a duration of 168 and 264 hours, respectively, with controlled pH. The spray mist deposits on the samples under analysis, covering them with a corrosive film of salt water. If, still prior to the CASS mist testing, the coating on the samples for investigation is scored down to the substrate with a blade incision, the samples can be investigated for their level of under-film corrosion in accordance with DIN EN ISO 4628-8 (03-2013), since the substrate corrodes along the score line during the CASS mist test. As a result of the progressive process of corrosion, the coating is undermined to a greater or lesser extent during the test. The extent of undermining in [mm] is a measure of the resistance of the coating. Assessment takes place on the basis of characteristic values in the range from 0 (no under-film corrosion) to 5 (significant corrosion). Each of the tests is performed three times and an average value is determined.

9. ICP-OES

The amount of certain elements in a sample under analysis, such as of titanium, zirconium and hafnium, is determined using inductively coupled plasma atomic emission spectrometry (ICP-OES) according to DIN EN ISO 11885 (date: Sep. 1, 2009).

10. Filiform Corrosion (FFC) to DIN EN 3665 (08-1997)

Determining the filiform corrosion is used to ascertain the corrosion resistance of a coating on a substrate. This determination is carried out according to DIN EN 3665 (08-1997) over a duration of 1008 hours. In the course of this time, the coating in question, starting from a line of induced damage to the coating, is undermined by corrosion that takes the form of a line or thread. The maximum and average thread lengths in [mm] are measured.

11. Climate Change Test PV 1210

This climate change test is used to determine the corrosion resistance of a coating on a substrate. The climate change test is carried out in 30 so-called cycles.

Before and after each of the 30 cycles of the climate change test, the coated substrates are exposed to a stone impact test according to DIN EN ISO 20567-1 (07-2017), whereby the test is always carried out on a specific position of the substrate surface. The evaluation is based on characteristic values in the range from 0 (best value) to 5 (worst value).

Further, if the coating of the specimens to be tested is scored down to the substrate with a knife cut before the climate change test is performed, the specimens can be tested for their degree of under-film corrosion in accordance with DIN EN ISO 4628-8 (03-2013), since the substrate corrodes along the scoring line during the climate change test. As corrosion progresses, the coating is more or less infiltrated during the test. The degree of undermining in [mm] is a measure of the resistance of the coating.

12. VDA Climate Change Test (VDA 621-415)

This climate change test is used to determine the corrosion resistance of a coating on a substrate. The climate change test is carried out in 10 so-called cycles.

Before and after each of the 10 cycles of the climate change test, the coated substrates are exposed to a stone impact test according to DIN EN ISO 20567-1 (07-2017), whereby the test is always carried out on a specific position of the substrate surface. The evaluation is based on characteristic values in the range from 0 (best value) to 5 (worst value).

Further, if the coating of the specimens to be tested is scored down to the substrate with a knife cut before the climate change test is performed, the specimens can be tested for their degree of under-film corrosion in accordance with DIN EN ISO 4628-8 (03-2013), since the substrate corrodes along the scoring line during the climate change test. As corrosion progresses, the coating is more or less infiltrated during the test. The degree of undermining in [mm] is a measure of the resistance of the coating.

### EXAMPLES

The following examples further illustrate the invention but are not to be construed as limiting its scope.

1. Phosphatizing Compositions

A number of inventive and comparative aqueous compositions have been prepared for use as phosphatizing composition.

Comparative Composition CPC1

CPC1 contains 1.3 g/l Zn, 1 g/l Mₙ, 14 g/l PO₄³⁻ (calculated as P₂O₅), 3 g/l NO₃⁻ and 1 g/l Ni. CPC1 was heated so that it is used having a temperature of 53° C.

Inventively Used Composition IPC1

IPC1 contains 1.3 g/l Zn, 1.5 g/l Mₙ and 13 g/l PO₄³⁻ (calculated as P₂O₅). IPC1 was heated so that it is used having a temperature of 45° C. IPC1 does not contain Ni.

2. Rinsing Compositions

A number of inventive and comparative aqueous compositions have been prepared for use as rinsing compositions.

Comparative Rinsing Composition CRC1

CRC1 contains 120 mg/l ZrF₆²⁻ (calculated as Zr) and has a pH-value of 4.0.

Comparative Rinsing Composition CRC2

CRC2 is identical to CRC1 with the exception that it additionally contains 50 mg/l Mo.

Inventive Rinsing Compositions IRC1 and IRC2 as Well as IRC3

Each of IRC1 and IRC2 has a pH-value of 4.0. Each of IRC1 and IRC2 and IRC3 contains 120 mg/l ZrF₆²⁻ (calculated as Zr). In addition, IRC1 contains 0.2 g/l of polymer P1, IRC2 contains 0.2 g/l of polymer P2 and IRC3 contains 0.1 g/l of polymer P2.

Each of polymers P1 to P2 is prepared by a controlled radical polymerization using O-ethyl S-(1-(methoxycarbonyl)ethyl) xanthate as a control agent.

Polymers P1 and P2 are each prepared by polymerization of a monomer mixture consisting of vinyl phosphonic acid (m1) and (meth)acrylic acid (m2). Polymer P1 is a block copolymer. Polymer P2 is a statistical copolymer. The following amounts of monomers (m1) and (m2) in mole-% have been used for preparing polymer (P1): 5 to mole-% of vinyl phosphonic acid (m1) and 85 to 95 mole-% of (meth)acrylic acid (m2). The following amounts of monomers (m1) and (m2) in mole-% have been used to for preparing polymer (P2): 5 to 15 mole-% of vinyl phosphonic acid (m1) and 85 to 95 mole-% of (meth)acrylic acid (m2). The sum of all monomeric units present in both polymers (P1) and (P2) adds up to 100 mole-%.

3. Inventive Method

3.1 An aluminum substrate (AA6014S; substrate T1) has been used. At first the substrate is treated with tap water (dipping, 60° C., 300 s). Then rinsing with tap water at room temperature for 30 s is performed. Afterwards the rinsed substrated is treated with deionized water (dipping, room temperature, 30 s).

Then, the substrate is treated with one of phosphatizing compositions (CPC1) or (IPC1). In case of CPC1 the substrate is treated by dipping into CPC1 having a temperature of 53° C. for 180 s. In case of IPC1 the substrate is treated by dipping into IPC1 having a temperature of 45° C. for 180 s.

Following the phosphatizing step, a rinsing step is performed (room temperature, tap water, 30 s).

Following the rinsing step, a contacting step with one of rinsing compositions CRC1, CRC2 or IRC1 to IRC2 is performed by dipping (room temperature, 30 s) or not performed.

A number of comparative and inventive examples are prepared in this manner. This is summarized in Table 1a.

| Example/Comparative | Phosphatizing | Rinsing |
|---|---|---|
| example | composition | Composition |
| C1 (comparative) | CPC1 (Ni-containing) | CRC1 |
| C2 (comparative) | IPC1 | — |
| C3 (comparative) | IPC1 | CRC2 |
| I1 (inventive) | IPC1 | IRC1 |
| I2 (inventive) | IPC1 | IRC2 |

After having performed the phosphatizing step and the contacting step (except of comparative example C2, wherein no such contacting has been carried out), the substrates obtained are then coated with a conventional commercially available multilayer-coat by subsequently applying a cathodically depositable electrocoat (CathoGuard® 800 of BASF Coatings GmbH) at 33° C. for 240-270 s at 250 V, curing to said electrocoat for 15 min at 175° C. (dry layer thickness 19-21 μm), a primer (Hydro-Füllgrund NxP-frei of Hemmelrath Technologies), a basecoat (Heliobase® obsidian black of Bohlig & Kemper) and a clearcoat (2K CeramiClear® of PPG Industries, Inc.) to the substrate.

3.2 An aluminum substrate (AA6014S; substrate T1) or a hot-dip galvanized steel substrate (HDG; substrate T2) or a cold rolled steel substrate (CRS; substrate T3) has been used. Each substrate is degreased with a commercially available degreasing agent and pretreated with a commercially available product (Gardolene® V). Then rinsing with tap water at room temperature for 30 s is performed.

Afterwards, each of the substrates is treated with phosphatizing composition (IPC1). The substrate is treated by dipping into IPC1 having a temperature of 45° C. for 180 s.

Following the phosphatizing step, a rinsing step is performed (room temperature, tap water, 30 s). Following the rinsing step, a contacting step with one of rinsing compositions CRC1, IRC2 or IRC3 is performed by dipping (room temperature, 30 s).

A number of comparative and inventive examples are prepared in this manner. This is summarized in Table 1 b.

TABLE 1b
Overview of phosphatizing compositions
and rinsing compositions used

| Example/Comparative | Phosphatizing | Rinsing |
|---|---|---|
| example | composition | Composition |
| C4 (comparative) | IPC1 | CRC1 |
| I3 (inventive) | IPC1 | IRC3 |
| I4 (inventive) | IPC1 | IRC2 |

After having performed the phosphatizing step and the contacting step the substrates obtained are then coated as described above within item 3.1 with a conventional commercially available multilayer-coat.

4. Properties of the Coated Substrates

4.1 A number of properties of the coated substrates obtained by the inventive method described in item 3.1 have been investigated. These properties were determined according to the test methods described hereinbefore. The results are summarized in Tables 2 and 3 below.

TABLE 2

| Example/Comparative | Crosscut before | Crosscut before after |
|---|---|---|
| example | condensation test | condensation test |
| C1 (comparative) | 1 | 0 |
| C2 (comparative) | 1 | 0 |
| C3 (comparative) | 0 | 0 |
| I1 (inventive) | 0 | 0 |
| I2 (inventive) | 0 | 0 |

TABLE 3

| Example/Comparative | | |
|---|---|---|
| example | CASS test 168 h | CASS test 264 h |
| C1 (comparative) | 0.77 | 0.7 |
| C2 (comparative) | 1.43 | 1.93 |
| C3 (comparative) | 1.43 | 1.6 |
| I1 (inventive) | 1.16 | 1.5 |
| I2 (inventive) | 0.8 | 1 |

From Table 3 it is evident that good results with nickel-containing phosphatizing treatment (with CPC1) and subsequent zirconium-containing rinsing (CRC1) can be achieved when performing the CASS test—both after 168 and after 264 hours (comparative example C1). The results, which are achieved with nickel-free phosphatizing treatment without any rinsing are significantly worse (comparative example 2). Above all, the result after 264 hours of the CASS is inacceptable for comparative example C2. A Zr— and Mo-containing rinsing after nickel-free phosphatizing treatment achieves a certain improvement (comparative example C3). However, the use of a polymer-containing rinsing solution (IRC1 and IRC2) in combination with a prior nickel-free phosphatizing treatment according to the invention results in significantly better values. The best results are provided by example 12.

4.2 A number of properties of the coated substrates obtained by the inventive method described in item 3.2 have been investigated. These properties were determined according to the test methods described hereinbefore. The results are summarized in Tables 3, 4 and 5 below.

TABLE 4
substrate T1 (AA6014S)

| | Filiform Corrosion | Filiform Corrosion |
|---|---|---|
| | (FFC): average | (FFC): maximum |
| Example/Comparative | thread length | thread length |
| example | [mm] | [mm] |
| C4 (comparative) | 4.8 | 13 |
| I3 (inventive) | 3.1 | 11.3 |
| I4 (inventive) | 3.1 | 11.6 |

From Table 4 it is evident that improved anti-corrosion properties are obtained when using a polymer (P) containing rinsing composition compared to a rinsing composition not containing such a polymer.

TABLE 5a
substrate T2 (HDG)

| | Stone impact test |
|---|---|
| Example/Comparative | performed after 10 cycles |
| example | of VDA climate change test |
| C4 (comparative) | 2.5 |
| I3 (inventive) | 1.7 |
| I4(inventive) | 1.7 |

From Table 5a it is evident that an improved stone chip resistance is obtained when using a polymer (P) containing rinsing composition compared to a rinsing composition not containing such a polymer.

TABLE 5b
substrate T2 (HDG)

| | Undermining [mm] after |
|---|---|
| Example/Comparative | 10 cycles of VDA climate |
| example | change test |
| I3 (inventive) | 1.6 |
| I4 (inventive) | 1.8 |

TABLE 6
substrate T2 (CRS)

| | | Stone impact |
|---|---|---|
| | Undermining [mm] | test performed |
| | after 30 cycles of | after 30 cycles of |
| Example/Comparative | PV 1210 climate | PV 1210 climate |
| example | change test | change test |
| C4 (comparative) | 1.9 | 3.7 |
| I3 (inventive) | 1.4 | 3.3 |
| I4 (inventive) | 1.3 | 3.0 |

From Table 6 it is evident that improved anti-corrosion properties and an improved stone chip resistance are obtained when using a polymer (P) containing rinsing composition compared to a rinsing composition not containing such a polymer.

1. A method for treatment of at least one surface of a substrate, wherein said surface is at least partially made of at least one metal, the method comprising at least steps (1) and (3), namely,
(1) contacting said at least one surface with an acidic aqueous composition (A) being free from nickel cations to form a conversion coating on said surface, the acidic aqueous composition (A) comprising at least
(a-i) zinc cations,
(a-ii) manganese cations, and
(a-iii) phosphate anions,
(2) optionally rinsing and/or drying the conversion coating obtained after step (1), and
(3) contacting the conversion coating obtained after step (1) or optionally after step (2) with an aqueous composition (B), the aqueous composition (B) being free from nickel cations, being different from acidic aqueous composition (A), and comprising one or more linear polymers (P) prepared by controlled radical polymerization containing at least
(m1) vinyl phosphonic acid and
(m2) (meth)acrylic acid
in form of their polymerized monomeric units,
wherein 85 to 95 mol-% of the polymerized monomeric units are polymerized monomeric units of (meth)acrylic acid (m2), and the rest of the polymerized monomeric units are polymerized monomeric units of vinyl phosphonic acid (m1).

2. The method according to claim 1, characterized in that acidic aqueous composition (A) comprises zinc cations (a-i) in an amount of 0.3 to 3.0 g/l, manganese cations (a-ii) in an amount of 0.3 to 3.0 g/l, and phosphate anions in an amount of 8.0 to 25.0 g/l (calculated as P₂O₅).

3. The method according to claim 1, characterized in that acidic aqueous composition (A) comprises fluoride anions in an amount of 10 to 250 mg/l and/or flurometallate anions in an amount of 0.05 to 5.0 g/l.

4. The method according to claim 1, characterized in that acidic aqueous composition (A) comprises nitrate anions in an amount of less than 1 g/l.

5. The method according to claim 1, characterized in that acidic aqueous composition (A) has a pH in a range of 0.5 to 6.5.

6. The method according to claim 1, characterized in that polymer (P) is present in the aqueous composition (B) in an amount of 5 to 5000 ppm, based on a total weight of the aqueous composition (B).

7. The method according to claim 1, characterized in that polymer (P) present in aqueous composition (B) consists of vinyl phosphonic acid (m1) and (meth)acrylic acid (m2) in form of their polymerized monomeric units.

8. The method according to claim 1, characterized in that aqueous composition (B) comprises one or more metal compounds (M) selected from the group consisting of titanium compounds, zirconium compounds, hafnium compounds, and mixtures thereof.

9. The method according to claim 1, characterized in that aqueous composition (B) comprises fluoride anions and/or flurometallate anions.

10. The method according to claim 1, characterized in that aqueous composition (B) is an acidic aqueous composition having a pH in a range of 0.5 to 6.5.

11. An aqueous composition (B) as defined in claim 1.

12. A master batch to produce the aqueous composition (B) according to claim 11 by diluting the master batch with water and optionally by adjusting a pH value.

13. A kit-of-parts comprising
an acidic aqueous composition (A) as defined in claim 1 and
an aqueous composition (B) as defined in claim 1.

14. A kit-of-parts comprising
a master batch to produce the acidic aqueous composition (A) as defined in claim 1 by diluting the master batch with water and optionally by adjusting a pH value, and
a master batch to produce the aqueous composition (B) as defined in claim 1 by diluting the master batch with water and optionally by adjusting a pH value.

15. A coated substrate obtainable by the method according to claim 1.
